(19) United States
(12) Patent Application Publication
(10) Pub. No.: US 2011/0290379 A1
(43) Pub. Date: Dec. 1, 2011

(54) METHOD AND USE FOR TEXTURED DYSPROSIUM

(75) Inventors: Alex Y. Murokh, Sherman Oaks, CA (US); Pedro E. Frigola, Culver City, CA (US); Ronald B. Agustsson, Rolling Hills Estates, CA (US)

(73) Assignee: RADIABEAM TECHNOLOGIES, LLC, Los Angeles, CA (US)

(21) Appl. No.: 13/102,488

(22) Filed: May 6, 2011

Related U.S. Application Data
(60) Provisional application No. 61/332,177, filed on May 6, 2010.

(51) Int. Cl. B32B 37/02; B32B 37/14; B32B 37/10; B32B 37/06; C22F 1/00; B32B 37/12

(52) U.S. Cl. 148/527; 148/559

(57) ABSTRACT

A method of making a magnetic field concentrator, comprising cold rolling a first metal sample that includes dysprosium to a foil having a thickness of between 20 microns and 60 microns; and further annealing the foil at a temperature of between 1000 and 1300 degrees C., for a period of between 10 minutes and 20 minutes. Preferably, annealing the foil takes place in an oxygen-free chamber, where the chamber is made from a material selected from at least one of molybdenum, tantalum, and titanium. Finally, at least a second sheet of annealed foil is produced, and the first and second foils are laminated together to produce a laminated sheet suitable for use as a magnetic field concentrator.

### CROSS-REFERENCES TO RELATED APPLICATIONS

The present application claims the benefit of provisional application 61/332,177 filed on May 6, 2010, which is incorporated herein by reference.

### BACKGROUND OF THE INVENTION

The present invention relates to the field of cryogenic magnetic devices, and a method of manufacturing a novel ferromagnetic material—which we call “textured dysprosium” or “TD.” In one aspect of the invention, TD is combined with high temperature superconducting (HTS) wires, to achieve ultra high magnetic flux not achievable in the prior art.

Dysprosium metal (symbolized herein by “Dy”) has a hexagonal close packed (hcp) crystalline structure, schematically exemplified in FIG. 1. This type of structure usually imposes strong anisotropy on the magnetic properties of the material. As a result, each crystal of dysprosium is magnetically very “hard” (i.e., difficult to saturate) when the external magnetic field is applied normal to the basal plane [0002] of a crystal, in the direction [0001] as indicated in FIG. 1. However, saturation is much easier when the magnetic field is applied parallel to the basal plane. There are two magnetically important directions in the basal plane [0002]: the easy direction <11-20> and the moderately hard direction <10-10>. In practical terms it typically takes about 1 kOe (kilo-oersted) to saturate a Dy single crystal along the <11-20> direction, 10 kOe for the <10-10> direction, and about 20 kOe for the [0001] direction. Dy becomes ferromagnetic below 90° K. It has a the highest known saturation field of any substance, reaching up to 3.8 Tesla at 4.2 K.

A polycrystalline Dy sample, which is comprised of randomly oriented domains, would be a very hard ferromagnetic material. Hence, practical applications for Dysprosium have thus far been limited to use in the form of “concentrators” for very high-field magnets. However, to achieve greater than 3 Tesla induction in the case of a single crystal concentrator, it would be necessary to ensure that the external magnetic field is directed parallel to the <11-20> direction. (FIG. 1.) A straightforward solution would be cutting the pole from a single crystal. Yet, Dy single crystals are traditionally grown by the Bridgman method and crystals resulting from this method are much too small and expensive to be used in insertion device applications. As used herein, an “insertion device” refers to a component part of a synchrotron which produces highly-brilliant, forward-directed synchrotron radiation.

### PRIOR ART

Therefore, in the early 1970's, Westinghouse research group suggested using a secondary recrystallization process to manufacture large-scale Dy foils. The Westinghouse approach was to (a) hot-roll ingots of Dysprosium to create 1.0 mm-0.5 mm thick foils and (b) to re-crystallize the resulting foils by annealing at 1,100° C. for several hours. The process yielded relatively large (several mm) grain sizes of Dy.

While this approach made it theoretically feasible to realize the full potential of Dysprosium and achieve the magnetization levels of a single crystal, the Westinghouse approach has several practical drawbacks and problems:

First, making magnetically uniform poles (or magnetic field “concentrators”) requires labor-intensive alignment of large-grain foils. This is because in a large-grain foil the difference in the permeability of the two major in-plane directions, <11-20> and <10-10>, becomes quite noticeable.

Second, prolonged heat treatment is required to ripen a few secondary nuclei into several millimeter grains. Prolonged heat treatment results in inevitable oxidation of the Dy foil surface and deeper grain boundary oxidation. But oxide formation prevents densification of the assembled pole and a resulting low-density pole accordingly has proportionately lower magnetic saturation, thus negating the advantage of potentially high saturation of Dy metal. In order to avoid oxidation during several hours of annealing at about 1,100° C. requires expensive ultra-high vacuum equipment or the use of ultra high purity gases, due to very low Gibbs energy of dysprosium oxide formation.

Third, it has been found that foils made in this way tend to re-crystallize, and only 20% of foils made in this way do not eventually re-crystallize. Thus the yield of the process by Westinghouse is intrinsically low. These are considerable disadvantages.

Thus, there is a need in the art for a method of making Dysprosium that overcome these disadvantages. The present invention addresses these, and other needs.

### SUMMARY OF THE INVENTION

The present invention includes a novel method of making a magnetic field concentrator. The method is capable of producing a concentrator capable of extremely high magnetic saturation. The method comprises cold rolling a first metal sample that includes dysprosium into a foil having a thickness of between 20 microns and 60 microns. In a preferred aspect, the sample is more than 90% by weight dysprosium. The foil is then annealed at a temperature of between 1,000 and 1,300 degrees C., for a period of between 10 minutes and 20 minutes. In a preferred aspect, annealing the foil includes annealing at a temperature of between 1100 and 1200 degrees C. In an even further preferred aspect, annealing the foil includes annealing at a temperature of between 1140 and 1160 degrees C. Preferably, annealing the foil takes place in an oxygen-free chamber, which is desirably made from a material selected from at least one of molybdenum, tantalum, and titanium. This feature chemically bonds residual gasses such as oxygen and water vapor, thereby lowering the pressure of the chamber and lowering the oxygen content. We call the resulting product “Textured Dysprosium” or “TD,” and the novel advantageous properties of the product are set forth more fully below.

Finally, the method of the invention includes following the same steps described above for producing a first foil, to produce at least a second foil, and laminating the first and second foils together to produce a laminated sheet. A plurality of foils may be laminated, depending on the desired thickness of the resulting sheet.

It has been found that the resulting laminated sheet of textured Dysprosium has extremely advantageous magnetic properties, as set forth more fully below.

The scope and advantages of the invention will be further understood with reference to the drawings and the detailed description of the preferred embodiment set forth below.

### BRIEF DESCRIPTION OF THE DRAWINGS

FIG. 1 shows a schematic representation of a hexagonal close-packed (hcp) structure as evidenced by Dysprosium, showing magnetically important crystallographic directions.

FIG. 2 shows, schematically, certain steps that may be used in foil manufacturing.

FIG. 3a shows an optical surface micrograph of as-rolled 60 micron Dy foil.

FIG. 3b shows the effect of 10 minutes annealing of the sample in FIG. 3a at 1050° C., on bright-field micrograph in which re-crystallization has taken place.

FIG. 3c shows a schematic illustration of the crystalline structure of the foil shown in

FIG. 3a.

FIG. 3d shows a schematic illustration of how the better oriented primary grains of FIGS. 3a and 3c become nuclei of large secondary grains consuming misoriented primary grains of as-rolled tape, which results in the structure of the re-crystallized foil of FIG. 3b.

FIG. 3e shows on bright-field micrograph a detail from FIG. 3b, and also a distribution curve showing the distribution of crystal orientations in the sample.

FIG. 4a is a chart reflecting experimental magnetization curves of as-rolled and recrystallized foils at 77 K.

FIG. 4b is a chart reflecting experimental magnetization curves of a laminated TD sample. The TD sample shows saturation just under 3 T.

FIG. 5 shows a schematic depiction of an undulator design according to features of the present invention. The stacked layers of HTS tape are micro-machined to form air-gaps, effectively acting as magnetic “poles” in the structure. Introducing TD field concentrators into the gaps enhances the field on axis.

FIG. 6 shows a schematic basic geometry of a “trapped field” TD-HTS motor according to features of the present invention, in which Fe poles are replaced with TD poles.

FIG. 7 shows a schematic geometry of a Pr—Dy undulator assembly with keeper structure according to features of the present invention.

FIG. 8 shows a schematic layout of a hybrid magnet array geometries for 2D, 2D+side magnets, and 2D+side+top configurations according to features of the present invention.

FIG. 9 shows graphic simulations for the corresponding gap field as a function of the saturation inductance, showing the clear advantage of textured Dy over vanadium permendur.

### DETAILED DESCRIPTION OF THE PREFERRED EMBODIMENTS

With reference to the Figures, the present application describes an invention comprising a method that has been developed to solve the problem described above. The method, and resulting product, of the present invention is a departure from work performed in 1970s by Westinghouse Labs. We call the resulting inventive new material “textured dysprosium,” or “TD.”

### An Example of Our Method

While the scope of the invention is set forth in the claims below, we implemented one example of our inventive method by executing the following steps.

Initially, a sample of Dysprosium was cold rolled to impart a high degree of cold deformation and to apply a large cross section reduction to the sample. (See FIG. 2.) In a preferred aspect of the invention, the sample is more than 90% by weight dysprosium. A foil having a thickness in the range of less than 60 microns was produced. Preferably, the thickness is to be between 20 and 40 microns. The resulting cold-rolled foil has a large amount of cold deformation and is characterized by a high level of inhomogeneous strain and small grain size.

Then, the cold-rolled foil was heat treated annealed at 1,150° C. for the relatively short period of 15 minutes compared with the several hours used by the Westinghouse process. (Preferably, the annealing is to be between 10 and 20 minutes, and the temperature is to be between 1,120 and 1,300° C.).

To carry out our process, we implemented a simple annealing cell that enabled us to carry out heat treatments in low vacuum (between 10⁻⁶ and 10⁻⁵ Torr), using an oil diffusion pump and a nitrogen cold trap. Furthermore, annealing the foil was carried out in an oxygen-free chamber made from made from a material selected from at least one of molybdenum, tantalum, and titanium. This feature chemically bonds residual gasses such as oxygen and water vapor, thereby lowering the pressure of the chamber and lowering the oxygen content.

Finally, we assembled the foils in a laminated core capable of use as a concentrator. The lamination was achieved by pressing a stack of foils coated with Versomine epoxy and curing the stack for about one hour at 150° C.

### Physical Attributes of Resulting Foil Product

The crystal structure of the foil before and after annealing was studied by optical micrograph, and was tested for magnetic properties after various periods of heat treatment.

It was discovered that after 15 minutes of annealing at about 1,150° C., the initially small crystals in the foil had grown to be substantially enlarged, and also their orientations were substantially aligned with each other. Furthermore, the resulting alignment of the crystals was such that the basal plane [0002] of the crystals was substantially parallel with the surface of the foil. This provided the advantageous result that the crystals were aligned so that the basal plane of the crystals could easily be placed parallel with an applied magnetic field.

Furthermore, this short heat treatment was found to dramatically avoid the extent of the oxidation problem found in the prior art Westinghouse process.

Using this method, we produced substantially oxide-free foils compared with product of the Westinghouse process. Further, our process was found to have a 100% yield, which means that substantially no crystals in the annealed foil tended to assume their former alignment held prior to the annealing.

As to the laminated core that we assembled, the core had a density of greater than 90% theoretical density of bulk Dy, thereby demonstrating that the resulting foil is suitable for highly compact lamination.

### Images Taken During Execution of Example

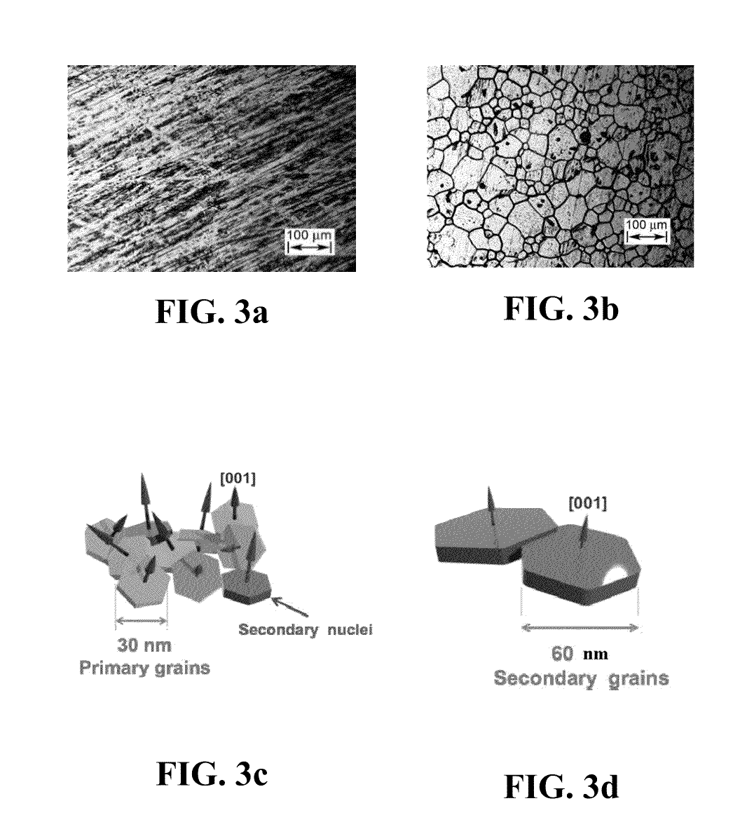

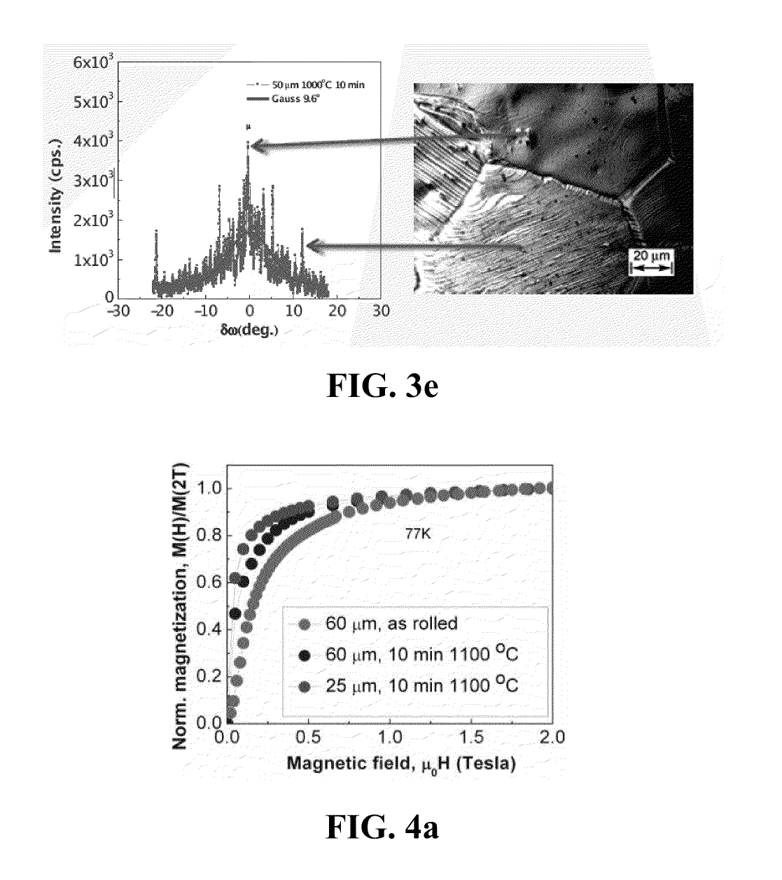

FIG. 3a shows an optical micrograph taken of a sample of Dysprosium after being cold rolled to a thickness of about 25 microns according to the method of the present invention. As may be noted, the crystalline structure of the cold rolled sample exhibits small crystals (10-20 nm) whose orientations are fairly randomly distributed with respect to each other.

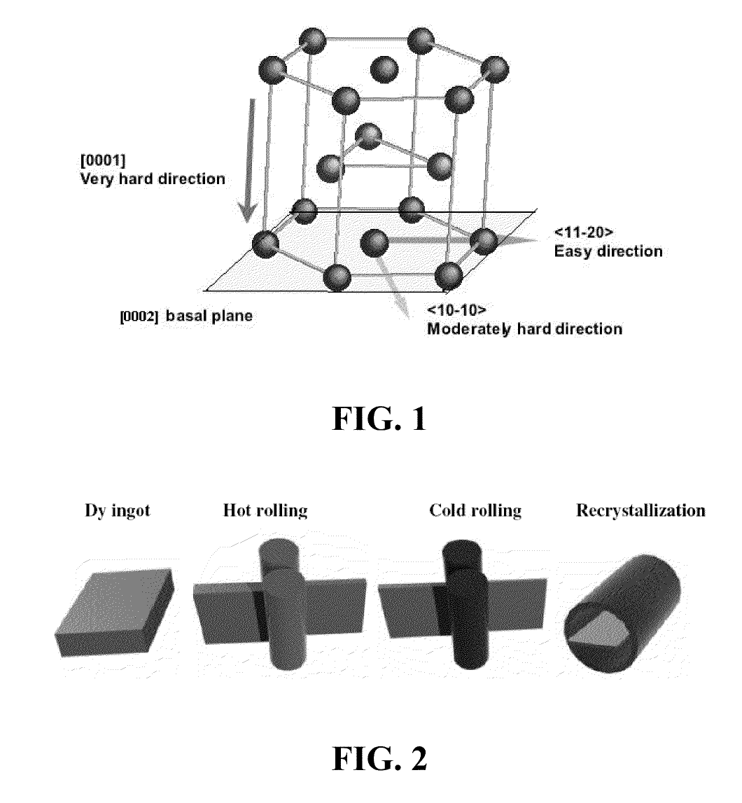

FIG. 3b shows an optical micrograph taken of the same Dysprosium sample as in FIG. 3a, after the sample had been annealed for about 15 minutes, at a temperature of about 1,150° C. As may be noted in FIG. 3b, crystals whose orientations were randomly distributed with respect to each other (FIG. 3a) have, surprisingly, been re-oriented and have coalesced together to produce larger crystals of approximately 20-60 nm. Most significantly, the larger crystals have all achieved an alignment in which the basal plane of the composite crystal (as indicated by [0002] in FIG. 1) is substantially parallel with the surface of the foil.

FIG. 3e shows, on the right, an enlarged image taken from the annealed foil shown in FIG. 3d. It may be observed that the inclination of the basal plane of some of the crystals is parallel to the plane of the foil, and that others are oriented only slightly offset from parallel. On the left side of FIG. 3e a distribution curve (obtained by a process of X-Ray diffraction) shows that crystal orientation in the sample as a whole has a “normal” Gaussian distribution, with a mean of zero degrees (between base plane and surface of the foil), and standard deviation of about 4 degrees. This is a surprising result, and produces excellent magnetic properties which are described below.

### Elaboration on Observations

The physical mechanism of the process wherein a cold rolled Dysprosium foil is annealed according to the method of the present invention (and seen in FIGS. 3a and 3b) is schematically explained with reference to FIG. 3c and FIG. 3d respectively. The cold rolled foil of FIG. 3a is schematically exemplified in FIG. 3c. It is polycrystalline, and comprised of small (10-30 nm) primary Dy grains with random orientation. Some grains have “favorable” orientation, that is to say, the [0001] direction is parallel to the foil normal—or, stated differently, the fast-growth basal plane [0002] is parallel to the foil surface. When this cold rolled foil is annealed according to the method of the invention, these “favorably” oriented domains appear to have a small energetic advantage over other grains, and, as was found to be the case, start “consuming” by incorporation, misoriented primary grains during the annealing process, thus imparting the same “favorable” orientation to the incorporated grains. The resulting secondary grains expand rapidly in the direction of the basal plane by further incorporation, and eventually the foil has only very large (20-60 nm), well-oriented secondary grains as seen in FIG. 3b, and schematically represented in FIG. 3d. This resulting crystal configuration provides the desired novel properties of the inventive Textured Dysprosium.

### Measurements Taken

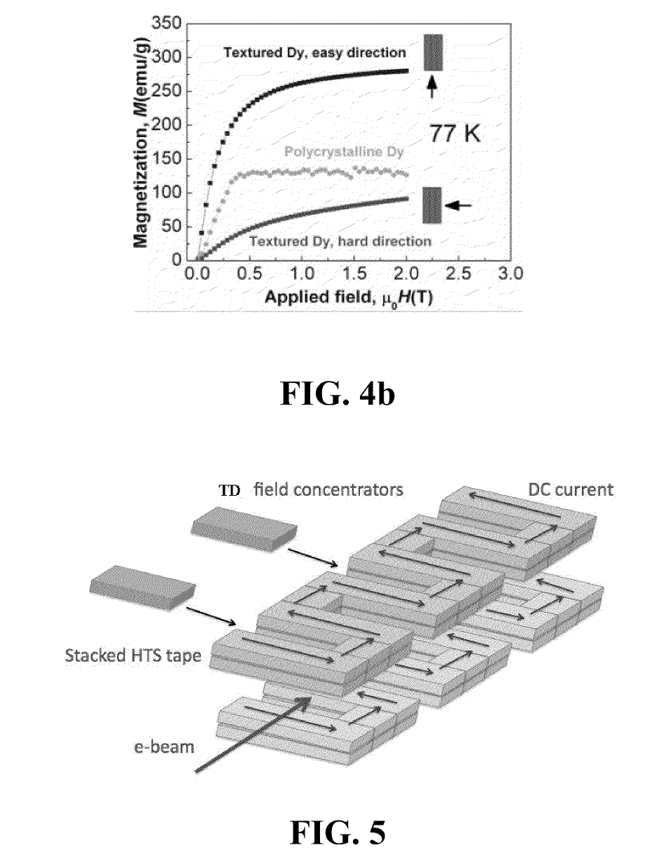

In addition to optical micrograph images being taken of the TD foil, magnetic measurements were also taken. As reflected in the chart in FIG. 4a, the TD foil demonstrated large improvements in hysteresis curve characteristics over the polycrystalline non-annealed sample, particularly when a thinner Dy foil (25 micron) was used.

Therefore, a batch of 25 micron foils produced by the method described was laminated to produce a 0.5×5.0×5.0 mm composite TD concentrator. This concentrator was tested. The concentrator demonstrated strong anisotropic behavior, correlating well with the known behavior of a single crystal, and had a magnetic field on the order of 2.8 T at saturation. This characteristic is reflected in FIG. 4b, and represents a very high comparative level of saturation.

The result of this inventive method is a novel material, which we call Textured Dysprosium (“TD”), that may be fabricated using the method as described. It has significant potential for high-performance magnetic applications. The present inventive method of TD fabrication is much more economical than the currently used Bridgman method for growing single crystals of Dysprosium, and it may be scaled up to produce large quantities of the Textured Dysprosium foil, and laminated sheets of foil, suitable for magnetic field concentrator uses.

Uses for Material from the Inventive Method

### A. Insertion Devices

Undulator and wiggler magnets are absolutely essential to the operation of Synchrotron Light Sources and Free Electron Lasers (FELs). An undulator is a magneto-static device (most often comprised of permanent magnets) which induces a periodic transverse trajectory modulation of a relativistic electron beam, which in turn results in emission of monochromatic X-rays of interest to the synchrotron radiation users. At present, the most reliable short period insertion devices developed on a practical scale are In-Vacuum Undulators (IVUs) based on permanent magnet technology. IVUs were initially introduced for light source applications in the early 80's, and quickly became the standard in the synchrotron radiation community. A particularly strong users demand exists however for hard X-rays, which generation requires shorter periods and stronger magnetic fields than available with conventional IVU technology, hence new materials and new design approaches are under investigation in multiple laboratories around the world.

State-of-the-art IVUs utilize permanent magnet materials such as neodymium ferrite (Nd₂Fe₁₄B) and samarium-cobalt (Sm₂Co₁₇) with remnant field on the order of 1.0-1.1 T (even higher remnant field grades of NdFeB are available, but due to lower coercivity and associated demagnetization risks are impractical for ambient temperature undulators). An incremental improvement in peak fields can be achieved in a hybrid configuration IVU, which combines permanent magnets with high saturation ferromagnetic pole pieces, yet these improvements are limited.

Another approach that has been used is a Cryogenic Permanent Magnet Undulator (CPMU), which is similar to an IVU but cryo-cooled to around 150 K. This concept takes advantage of the higher coercivity of magnetic materials at lower temperatures, so a higher remnant field grade of NdFeB can be selected for the undulator magnets. CPMUs at 150 K can achieve 10-15% higher fields compare to the room temperature devices. A particularly promising version is the CPMUH (hybrid) device with permendur poles, since permendur is an excellent ferromagnetic material at about 150 K.

Another important direction of research towards shorter period devices is the development of superconducting undulators (SCU) capable of higher fields in compact geometries. Most of the SCU experience comes from utilizing NbTi wire (although an experimental investigation is under way to develop an SCU based on the Nb3Sn, which has higher critical current). One disadvantage of the SCUs is the low operating temperature (<10 K), which drives up considerably the cost and complexity of these devices.

High temperature superconducting (HTS) technology has the potential to significantly reduce these problems, but with some exceptions until recently has been given limited attention from insertion device developers due to lower critical current values in the HTS wires at 77 K, compared with the conventional superconducting wires at 4.2 K. However, recent progress in HTS wires based on epitaxial Y—Ba—Cu—O layers (so called second-generation or 2G wire) resulted in availability of practical HTS conductors with high critical current density suitable for high field applications.

A further innovation of the present invention is to utilize 2G HTS wire in combination with TD anisotropic field concentrators, to achieve record high magnetic fields for very short period undulators (FIG. 5).

In the inventive TD-HTS undulator, the TD foils may be stacked to make field concentrators, while the HTS wire provides the energizing magnetic field. The magnetic performance of an TD-HTS undulator offers significant benefits over any CPMU devices of similar geometry. Although, it is similar to the performance expected from cold superconducting technology, there are a number of important advantages which TD-HTS technology has over CSUs:

First of all, the TD-HTS device may use either liquid nitrogen cooling or single-stage closed loop cryo-cooler, which significantly reduces the complexity, capital and operational expenses, compared to the two-stage cryo-cooler required for operating Nb-based SCUs at liquid helium temperatures.

Second, cold CSU technology is vulnerable to the “warm core” problem, when a beam related heat load can damage the device. This issue is not nearly as significant at HTS temperatures, and the nitrogen refrigeration cycle have commercially available solutions for handling 100s of Watts of heat load without quenching the structure.

Third, the less bulky design of the cryogenic system of the present invention simplifies the access to the HTS undulator, which simplifies certain critical steps, such as shimming, structural adjustments or magnetic measurements.

### B. In-Vacuum High Performance Hybrid Undulator Configurations

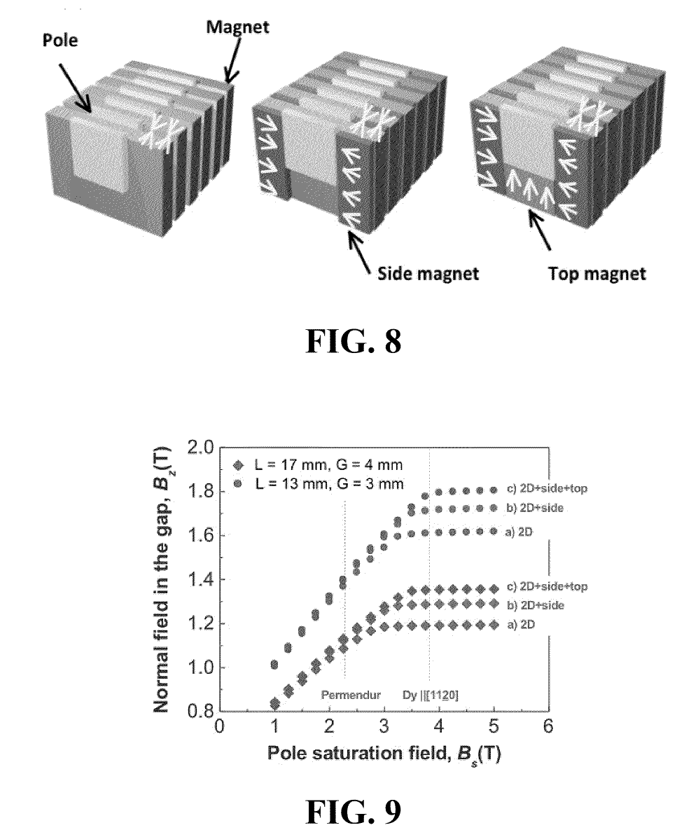

First we analyze feasibility of using re-crystallized Dy foils as poles of a cryo-cooled hybrid undulator. As an example we use geometry derived from the U-20 undulator designed for NSLS-II X-ray ring. A three different hybrid geometry design configurations has been used (FIG. 8), and magnetic simulations using code RADIA demonstrate that a ferromagnetic material with Bₛ>3 T (such as in TD (textured Dy)) does provides a significant advantage over vanadium permendur as the pole material (FIG. 9).

FIGS. 8 and 9 assume utilization of TD (textured Dy) with NdFeB, a widely used permanent magnet material due to its large energy product and ability to fine tune the magnetic properties for a given application by controlling dopant composition and impurity concentration in the lattice. In cryogenic applications, however, such magnets have a limitation associated with the spin-axis reorientation, which in NdFeB magnets starts at about 135 K and results in a deviation angle as large as 30° at lower temperatures. As a consequence, the remanent field in NdFeB magnets is peaked at 135 K and degrades with further cooling. To mitigate this deficiency, and to take a full advantage of TD (textured Dy) properties below 90 K, an experimental permanent magnet configuration is considered to replace 80% neodymium in the NdFeB with praseodymium (Pr). The resulting Nd_{0.2}Pr_{0.8}Fe₁₄B permanent magnet material does not show signs of spin-axis reorientation even at temperatures below 30 K, and at these low temperatures it shows improvement in remanent field and a large gain in coercivity with an energy product exceeding 1000 MGOe. As such, PrFeB is an ideal material for ultra-high performance cryo-cooled undulator applications, in combinations with TD (textured Dy) (FIG. 7).

### C. Electromagnetic Converters

The present invention is also applicable in another area, namely in the field of electromagnetic converters, such as motors and generators. The rapid advancement of HTS technology has triggered substantial interest towards superconducting motors and generators. Recently, experimental HTS air-core motors have shown significant performance advantages over conventional devices at very high power levels (>1 MW), such as those utilized in ship propulsion engines. The driving factors for these advances are the nearly lossless nature of HTS wires, the ultra-high magnetic flux density achievable with large volume HTS air-core rotors, and the lack of transient and reactance limited effects associated with iron saturation in conventional copper-wire and iron-core machines.

However, the extension of air-core HTS technology towards lower power machines (<1 MW) is not very practical, as the output power of HTS air-core motors scales roughly as the ˜(volume)^{5/3}, compared to linear scaling in conventional devices. In addition, the economic advantage of lossless HTS windings is less significant for smaller power consumption levels, while potential applications must support the relatively high capital and operating costs of HTS technology. As a result, most of the ongoing efforts in developing practical HTS devices are aimed at the high end of the power spectrum.

Nevertheless, there are market niches where HTS-based low to medium power motors (LMPM) have significant potential. Examples are: small, specific weight sensitive, high accuracy devices such as pump-drives for medical applications; and precision, response speed sensitive, high load-to-size ratio electro-magnetic actuators for defense and aerospace applications. In many such systems, the higher capital costs of HTS would be secondary to the improved performance. In addition, the adaptation of HTS systems in the LMPM market offers an excellent pathway to test the maturity of the HTS platform.

To take advantage of HTS technology in smaller-scale electro-magnetic converters, it is necessary to reintroduce ferromagnetic materials into the HTS rotor design. Of particular interest in the LMPM range are so called “trapped field” HTS motors, which use iron-YBCO anisotropic heterostructures to entrap high density magnetic field flux. Pilot projects have demonstrated very compact high torque density of trapped field devices in LMPM range.

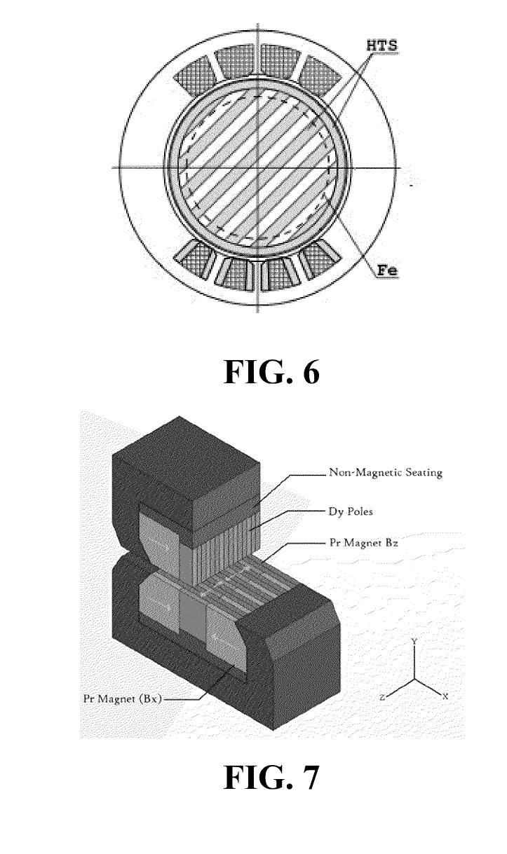

In one aspect, our invention is an electromagnet that combines a novel ferromagnetic material—textured dysprosium (TD)—with HTS wires, to achieve ultra high magnetic flux. The implementation of TD-HTS in high performance electro-magnetic and magneto-static devices can double the practically achievable power. FIG. 6 exemplifies one application for our novel material, and shows the basic geometry of a “trapped field” TD-HTS motor, in which iron (Fe) poles are replaced with TD poles.

The present invention may, of course, be carried out in other specific ways than those herein set forth without departing from the essential characteristics of the invention. The present embodiments are, therefore, to be considered in all respects as illustrative and not restrictive, while the scope of the invention is set forth in the claims that follow.

We claim:

1. A method of making a magnetic field concentrator, comprising:
cold rolling a first metal sample that includes dysprosium to a foil having a thickness of between 20 microns and 60 microns;
annealing the foil at a temperature of between 1000 and 1300 degrees C., for a period of between 10 minutes and 20 minutes.

2. The method of claim 1, wherein cold rolling a first metal sample includes cold rolling a sample that is more than 90% by weight dysprosium.

3. The method of claim 1, wherein annealing the foil includes annealing at a temperature of between 1100 and 1200 degrees C.

4. The method of claim 1, wherein annealing the foil includes annealing at a temperature of between 1140 and 1160 degrees C.

5. The method of claim 1, wherein annealing in an oxygen-free chamber includes annealing in a chamber made from a material selected from at least one of molybdenum, tantalum, and titanium.

6. The method of claim 1, further including following the steps of claim 1 to produce at least a second sheet of annealed foil, and laminating the first and second foils together to produce a laminated sheet.

7. The method of claim 6, wherein laminating the first and second foils together includes coating the foils with Versomine epoxy and pressing them together and curing them for about one hour at 150° C.
